(19) United States
(12) Patent Application Publication
(10) Pub. No.: US 2008/0134046 A1
(43) Pub. Date: Jun. 5, 2008

(54) Aggregated computer health

(75) Inventors: James Gray, Bellevue, WA (US); Cyra Richardson, Bellevue, WA (US); Kynan Antos, Seattle, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/633,914

(22) Filed: Dec. 5, 2006

(51) Int. Cl. G06F 15/177; G06F 15/173; H04L 9/00; G06F 11/14; G06F 21/00

(52) U.S. Cl. 715/736; 709/224; 726/3; 726/23; 714/4; 714/E11.112

(57) ABSTRACT

An aggregated network-wide status for computer health may be generated by calculating a network health status for each computer on the network, then aggregating the results into a single icon or status based on the worst health of all the network computers. The computer health may be presented as a pictorial map of the network with the health of each system indicated individually, or may be a matrix of each system with the particular components making up the health of the system individually presented.

### BACKGROUND

Monitoring computer health is an important aspect of maintaining a network of computers. Computer health relates to keeping the system operating at a high level of efficiency. This may include making sure that the system is clean of malicious software, installed applications are up to date, regular maintenance procedures have been fulfilled, processes are operating without errors, and monitoring various performance parameters.

With today's computer systems becoming ever more complex, the task of maintaining a computer network may be complex for a trained system administrator. As more and more homes begin to have two or more computers, small home networks are becoming more commonplace. Such small networks can become very intimidating for a novice system administrator.

### SUMMARY

An aggregated network-wide status for computer health may be generated by calculating a network health status for each computer on the network, then aggregating the results into a single icon or status based on the worst health of all the network computers. The computer health may be presented as a pictorial map of the network with the health of each system indicated individually, or may be a matrix of each system with the particular components making up the health of the system individually presented.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a pictorial illustration of an embodiment showing a network with a health monitoring system.

FIG. 2 is a diagram illustration of an embodiment showing a health monitoring system.

FIG. 3 is a pictorial illustration of an embodiment showing a user interface for a monitoring system.

### DETAILED DESCRIPTION

Network monitoring and maintenance may be performed through an interface that aggregates a computer health status of several devices into a simple nomenclature. The status of the network is determined by the worst status of any device that is aggregated. The status may be presented to a user through a simple icon or a status screen.

The network monitoring and maintenance system may present several user interfaces, including a network map and a matrix of the various devices with the status of each system making up the device health. In many instances, a problem condition may be presented with a task that may be initiated to address the problem.

Specific embodiments of the subject matter are used to illustrate specific inventive aspects. The embodiments are by way of example only, and are susceptible to various modifications and alternative forms. The appended claims are intended to cover all modifications, equivalents, and alternatives falling within the spirit and scope of the invention as defined by the claims.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

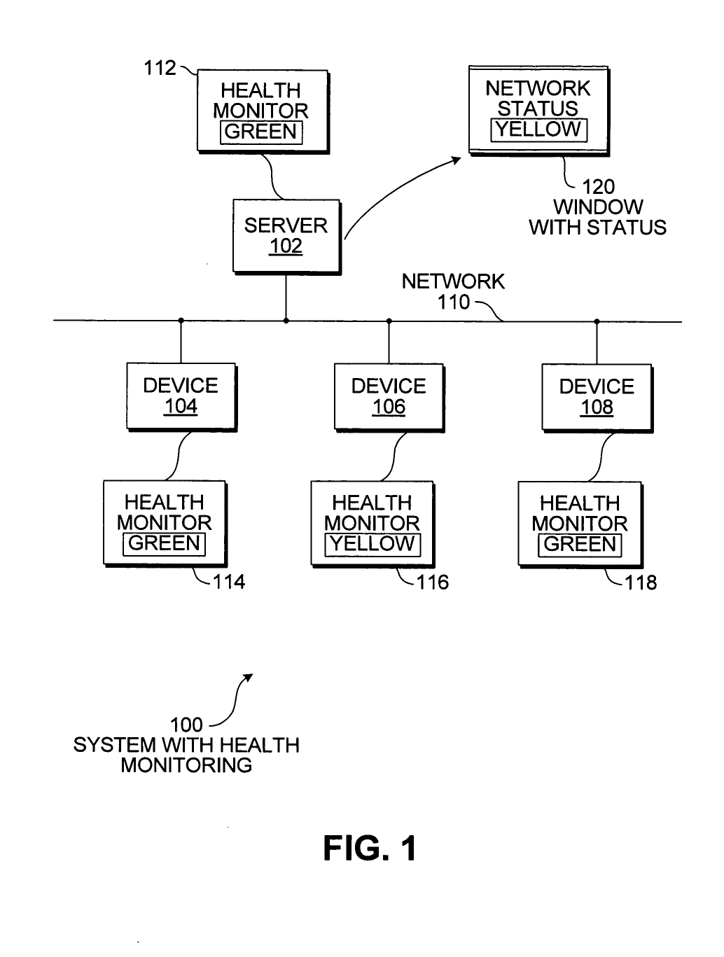

FIG. 1 is a diagram of an embodiment 100 showing a system with computer health monitoring. A server 102 is connected to several devices 104, 106, and 108 through a network. The devices 104, 106, and 108 may be personal computers, network appliances, game machines, or any other type of device capable of connecting to a network. In some instances, the network 110 may be a hardwired, wireless, or combination of wired and wireless networks.

Each device, including the server 102, may have a health monitor. For example, devices 104, 106, and 108 have health monitors 114, 116, and 118, respectively and server 102 has health monitor 112. The health monitor may be a software or hardware component operable on the respective device and capable of determining a health status for the device. In some instances, a software component may be operable on the device itself to determine a status, whereas in other instances, another device, such as the server 102, may probe a device to determine its status.

The health status of each of the devices being monitored may be distilled into a few levels of status. The health status may aggregate the status of several monitored systems on a device to determine an overall health. In one embodiment, the status levels may be green, yellow, and red. A green status may indicate that the health is good and no action is necessary. Yellow may indicate that one or more monitored systems are below optimum and some action may be taken, and red may indicate that one or more systems are critical and immediate action is appropriate. Different embodiments may use various methods and techniques to indicate an overall health.

The health status of each of the monitored devices is aggregated by the server 102 to generate a window 120 that displays an aggregated status. In the present embodiment, each of the devices 104, 108, and the server 102 have a status of ‘Green’. However, the device 106 has a status of ‘Yellow’. The aggregated status of in the administrative window 120 is therefore ‘Yellow’, which is the worst status of any monitored device in the embodiment 100.

The window 120 displays a single status for the entire network of monitored devices. The single status shown in window 120 may be a quick reference for a network administrator to see if any problems exist. In some embodiments, the status shown in the window 120 may be displayed as a stand-alone colored icon on a display. Various embodiments may have different mechanisms to display the aggregated status.

In some cases, the status may be displayed for any user that has administrative privileges. For example, an administrator may log onto device 104 and an icon indicating the network health status may be generated by server 102 and displayed on device 104 while that user is logged on. In other embodiments, the status may be available while that user is logged onto the server 102.

Some networks may include non-monitored devices that do not provide a health status and would not be included in the aggregated health shown in the window 120.

The icon, window 120, or other indicator of overall health of a group of computers may give an administrator a quick status that may be continually or readily present. The icon, window 120, or other indicator may be interactive and able to launch a monitoring or administration window that gives an administrator detailed views of the status and may further provide links to perform various administrative tasks as illustrated hereinafter.

In some embodiments, a trusted relationship may be established between an administrative server and various client devices. A trusted relationship may be established by an authentication of a client device to a server device or vise versa. In some embodiments, the authentication may be performed on a user basis as opposed to performing authentication on a device basis. A trusted relationship may further include a specific setup routine where each client device is affirmatively identified to a server device. A trusted relationship may be desirable in situations where many devices may be accessible over a network but only a subset of devices are to be monitored and administered using the server 102.

Secure connections may be used between the server 102 and the client devices 104, 106, and 108. Because the server 102 may perform various administrative functions on the client devices, a secure connection may be desirable.

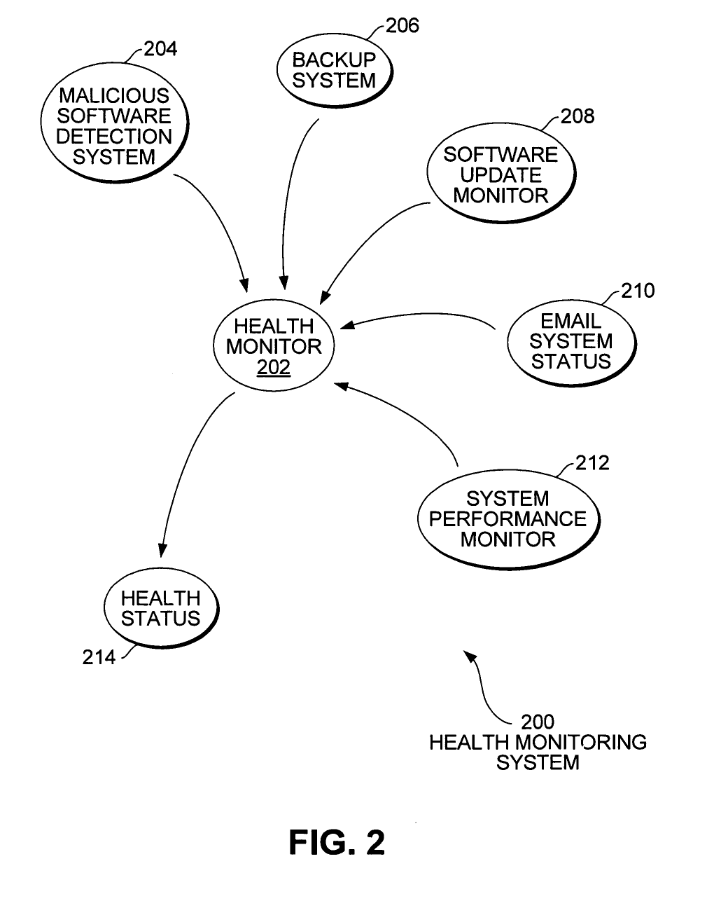

FIG. 2 is a diagram illustrating an embodiment 200 of a health monitoring system. A health monitor system 202 receives input from a malicious software detection system 204, a backup system 206, a software update monitor 208, an email system status 210, and a system performance monitor 212 to produce a health status 214.

The health monitor system 202 may monitor many different systems within a device. The embodiment 200 illustrates a possible health monitor system that is adapted to a personal computer. In an embodiment for a health monitor system for a different type of device such as a printer, the systems may include a count of printed pages since last maintenance, paper fill level, or other status items appropriate for the device.

The malicious software detection system 204 may be an anti-virus or anti-malware system that periodically monitors a device for the presence of harmful software. The health monitor 202 may monitor that updates to a malware library is performed, determine if an excessive number of potentially harmful software components have been detected, or provide any other relevant status items to the health monitor 202.

In some instances, the health monitor 202 may receive operating parameters from various systems and evaluate the parameters against a set of rules to determine a health status 214. In other instances, a system such as the malicious software detection system 204 may contain rules for determining a status and communicate a status to the health monitor 202.

The backup system 206 may provide status information concerning whether a backup was successfully completed, the last date of successful backup, whether sufficient storage space is available for future backups, or any other status item concerning data backup.

The components that make up the health status may provide information regarding various parameters associated with a specific component and may also provide monitoring of user activity with a component. In some instances, excessive user activity of a backup system, for example, may indicate that some administrative action may need to be investigated.

The software update monitor 208 may be a component that detects if updated versions of specific software applications are available for download and updating. In some instances, the software update monitor 208 may be a stand alone application that checks individually installed applications against a database of latest updates. In other instances, each installed application may have a mechanism for detecting if an update is available and communicate the information to the monitor 208.

An email system status monitor 210 may detect various settings and performance parameters for an email system and communicate with the health monitor 202. The email system status monitor 210 may include any useful parameter, such as mailbox capacity, whether a connection can be made to an email server, or any other measure of performance of an email system.

The system performance monitor 212 may include any type of parameter that can be used to determine whether a system is operating properly. For a personal computer, such parameters may include amount of virtual memory used, capacity of data storage devices, central processor unit usage, number of processes running, or any other parameter.

Embodiment 200 is an example of various factors that may be aggregated to determine a health status. Different devices and different configurations of various devices may have different systems and techniques for monitoring parameters specific to the device to determine a health status.

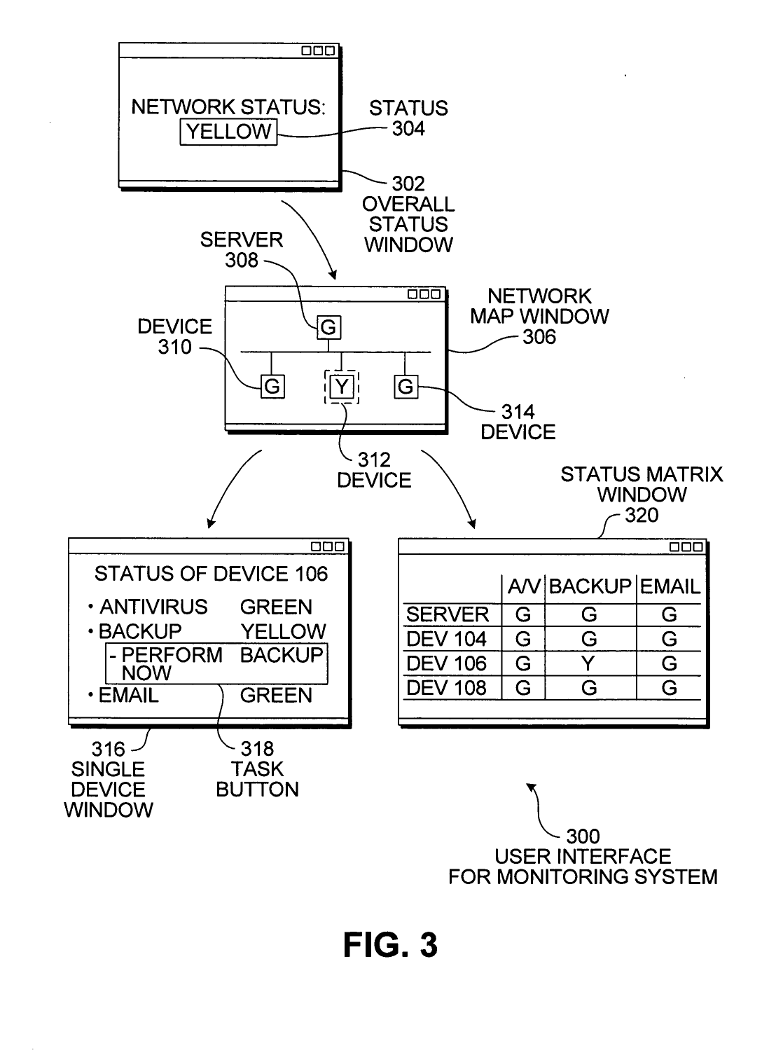

FIG. 3 is an illustration of an embodiment 300 showing a user interface for monitoring the network of embodiment 100. Window 302 contains the overall status of the network, and the status 304 is ‘Yellow’. Window 302 may be an icon or other representation on a display. The status 304 is a summary or aggregation of all the devices being monitored by the system. In the embodiment 100, device 106 had a status of ‘Yellow’ while all other devices on the network had a status of ‘Green’.

A user may enter a network map window 306 to display the various devices and their associated status on a visual map. Within the window 306, server 308 and devices 310, 312, and 314 correspond to the server 102 and devices 104, 106, and 108, respectively of embodiment 100. In the window 306, the server 308 has a ‘G’ indicating a ‘Green’ status as well as devices 310 and 314. Device 312 has a ‘Y’ indicating a ‘Yellow’ status.

While textual indicators are illustrated in the present embodiment, other embodiments may use color, shape, or different images to indicate the status of individual devices on the network map window 306.

A user may select the device 312 from the window 306 to bring a up a single device window 316 that displays a detailed status of a single device. In the present case, the status of device 106 is displayed in window 316. Three monitored systems are shown for device 106 along with the status of each device. In this case, ‘Antivirus’ has a status of ‘Green’, ‘Backup’ has a status of ‘Yellow’, and ‘Email’ had a status of ‘Green’. Beneath the ‘Backup’ status is a button 318 that may launch a task or instructions for performing a backup operation. The button 318 may perform the entire backup operation when a user selects the button 318, a wizard or other progressive interface may appear, a step by step instruction may be given, or any other help may be provided to the user.

The user interface of window 316 gives a user a status of the various monitored systems, but may also provide a link or instructions for providing a remedy for a problem. In some embodiments, other functions such as routine maintenance may also be shown to a user.

The user may select a status matrix window 320 that presents a matrix of several devices and the status of each system associated with the device. Along the vertical column are ‘Server’, ‘Dev 104’, ‘Dev 106’, ‘Dev 108’, corresponding to the respective devices of embodiment 100. Along the horizontal axis are the monitored systems, which in this case are ‘A/V’ for antivirus, ‘Backup’, and ‘Email’.

For each device and system, the status is ‘G’ for Green, except the ‘Backup’ system of ‘Dev 106’. While each embodiment may have different mechanisms for displaying and navigating the status data, a user may be able to click on, highlight, or otherwise select the ‘Y’ indicator and be presented with one or more options for how to remedy the problem. In some instances, the window 316 may be presented with the task button 318 to allow the user to perform a backup and remedy the situation.

The embodiment 300 illustrates one mechanism by which the aggregated status of a group of devices may be presented for monitoring as a single indicator. The single indicator, be it an icon or window with an overall status, may lead to a visual map of the network with the status of each individual device on the network. Another visual indicator may be a matrix of each device with the status of each individual monitored system. The user may be presented with links or instructions for remedying the problem.

Embodiment 300 is a mechanism that greatly simplifies the day to day monitoring and maintenance of a network. In some embodiments, the mechanism may be simplified and automated to the point that home users may be able to effectively maintain a small home network without a large amount of training or technical familiarity.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method comprising:
connecting a server to a plurality of devices;
for each of said plurality of devices, calculating a health status and transmitting said health status to said server;
calculating a network status being an aggregation of said health status for each of said plurality of devices, said network status being a worst status of said plurality of devices; and
presenting said network status.

2. The method of claim 1 further comprising:
establishing a trusted relationship between said server and each of said plurality of devices.

3. The method of claim 1 further comprising:
establishing a secure connection between said server and each of said plurality of devices.

4. The method of claim 1 wherein said health status comprises the status of at least one of a group composed of a malicious software detection system, a backup system, software updates, email system, and performance parameters.

5. The method of claim 1 wherein said health status is composed of three status levels.

6. The method of claim 1 wherein said health status is determined by each of said plurality of devices.

7. The method of claim 1 further comprising:
presenting a visual network map comprising each of said plurality of devices; and
presenting an individual health status for each of said plurality of devices.

8. The method of claim 1 further comprising:
presenting each of said plurality of devices; and
for each of said plurality of devices, presenting a status of each system used to calculate said health status.

9. The method of claim 8 further comprising:
presenting a link to initiate a remedial action for at least one of said systems.

10. A computer readable medium comprising computer readable instructions adapted to perform the method of claim 1.

11. A server comprising:
a network connection to a plurality of devices;
a processor adapted to:
establish a relationship with each of said plurality of devices attached to said network;
determine a health status for each of said plurality of devices, said health status comprising a status for at least one local system or local parameter;
determine said health status for said server;
determine a network health status, said network health status being a worst status of each of said plurality of devices and said server;
a user interface.

12. The server of claim 11, said user interface comprising a status icon, said status icon reflecting said network health.

13. The server of claim 11, said user interface comprising:
a presentation of a visual network map comprising each of said plurality of devices; and
a presentation of an individual health status for each of said plurality of devices.

14. The server of claim 11, said user interface comprising:
a presentation of each of said plurality of devices; and
for each of said plurality of devices, a presentation of a status of each system used to calculate said health status.

15. The server of claim 14, said user interface further comprising:
a presentation of a link to initiate a remedial action for at least one of said systems.

16. The server of claim 11, said health status comprising the status of at least one of a group composed of a malicious software detection system, a backup system, software updates, email system, and performance parameters.

17. The server of claim 11, said health status being composed of three status levels.

18. A user interface comprising:
a first presentation of a visual network map comprising each of a plurality of devices and for each of said plurality of devices, a health status for each of said plurality of devices, said health status comprising a status for at least one local system or local parameter; and
a second presentation of each of said plurality of devices and for each of said plurality of devices, a presentation of a status of each system used to calculate said health status.

19. The user interface of claim 18, said second presentation comprising a link to initiate a remedial action for at least one of said systems.

20. The user interface of claim 18 wherein said health status comprises the status of at least one of a group composed of a malicious software detection system, a backup system, software updates, email system, and performance parameters.
